(19) United States
(12) Patent Application Publication
(10) Pub. No.: US 2010/0289332 A1
(43) Pub. Date: Nov. 18, 2010

(54) POWER SUPPLY AND SEMICONDUCTOR TEST DEVICE USING THE SAME

(75) Inventor: Kenichi NARIKAWA, Tokyo (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION, Tokyo (JP)

(21) Appl. No.: 12/775,759

(22) Filed: May 7, 2010

(30) Foreign Application Priority Data
May 12, 2009 (JP) 2009-115427

(51) Int. Cl. H02J 4/00

(52) U.S. Cl. 307/38

(57) ABSTRACT

A negative polarity side of a positive-side parallel circuit and a positive polarity side of a negative-side parallel circuit are connected to a common potential point. Both parallel circuits have a primary-side power supply and a by-pass capacitor connected in parallel, respectively. A series circuit has one end connected to a positive polarity side of the positive-side parallel circuit and other end connected to a negative polarity side of the negative-side parallel circuit. A third switch has one end connected to a connection point between a first switch and a second switch of the series circuit and other end connected to the common potential point. A load has one end connected to a connection point of the first switch, the second switch and the third switch via an inductor and other end connected to the common potential point. A switch control circuit is configured to drive selectively respective switches.

### TECHNICAL FIELD

The present disclosure relates to a power supply and a semiconductor test device using the same and, more particularly, a power supply that is capable of handling a four-quadrant operation and has high efficiency and a semiconductor test device using the same.

### RELATED ART

FIG. 2 is a circuit diagram showing an example of a common step-down synchronous rectifying converter, and shows an example of a DC-DC converter that utilizes a switching operation and an energy charging/discharging of an inductor.

In FIG. 2, a by-pass capacitor 2 used for voltage stabilization is connected in parallel with a primary-side power supply 1. Also, a negative polarity side of this parallel circuit is connected to a common potential point, while a positive polarity side of this parallel circuit is connected to the common potential point via a series circuit consisting of a first switch 3 and a second switch 4, which are made of MOS FET, or the like respectively.

One end of a load 6 is connected to a connection point between the first switch 3 and the second switch 4, which are connected in series, via an inductor 5, while the other end of the load 6 is connected to the common potential point.

A connection point between the inductor 5 and the load 6 is connected to a switch control circuit 7. The switch control circuit 7 generates drive pulse signals that opens/closes alternately the first switch 3 and the second switch 4. A pulse width of these drive pulse signals is controlled to sense a voltage at the end portion of the load 6 and keep this voltage at the end portion of the load 6 constant.

In the step-down synchronous rectifying converter constructed as shown in FIG. 2, a power loss due to a voltage drop caused in the regulator itself is not generated, unlike the series regulator. Therefore, this step-down synchronous rectifying converter is used widely as the power supply whose efficiency is high.

In FIG. 2 in Patent Literature 1, a configurative example of the step-down synchronous rectifying converter similar to that in FIG. 2 is set forth.

[Patent Literature 1] JP-A-10-191624

However, such step-down synchronous rectifying converter can output only the output voltage with positive polarity. It is impossible for this rectifying converter to handle the generation of the voltage with both positive/negative polarities and the current direction of both polarities. Therefore, for example, upon testing the wafer by the semiconductor test device, it is difficult to apply this step-down synchronous rectifying converter to a parametric measurement unit (PMU) power supply. This is because, in order to measure the basic characteristics indicating to what extent the current is caused to flow when a DC voltage is applied to a transistor, a resistor, etc., the parametric measurement unit (PMU) power supply is requested to handle the four-quadrant operation on such a plane that an abscissa denotes a voltage and an ordinate denotes an electric current.

### SUMMARY

Exemplary embodiments of the present invention provide a power supply that is capable of handling a four-quadrant operation and has high efficiency and a semiconductor test device using the same.

A power supply according to an exemplary embodiment of the invention comprises:

a positive-side parallel circuit whose negative polarity side is connected to a common potential point, the positive-side parallel circuit having a primary-side power supply and a by-pass capacitor used for voltage stabilization, which are connected in parallel;

a negative-side parallel circuit whose positive polarity side is connected to the common potential point, the negative-side parallel circuit having a primary-side power supply and a by-pass capacitor used for voltage stabilization, which are connected in parallel;

a series circuit having a first switch and a second switch, the series circuit having one end which is connected to a positive polarity side of the positive-side parallel circuit and other end which is connected to a negative polarity side of the negative-side parallel circuit;

a third switch having one end which is connected to a connection point between the first switch and the second switch and other end which is connected to the common potential point;

a load having one end which is connected to a connection point between the connection point between the first switch and the second switch and the third switch via an inductor and other end which is connected to the common potential point; and

a switch control circuit configured to drive selectively respective switches by sensing a signal at a connection point between the inductor and the load.

The power supply may further comprise:

a first load which is connected to in parallel with the positive-side parallel circuit; and

a second load which is connected to in parallel with the negative-side parallel circuit.

In the power supply, the first load and the second load may be power regenerative circuits that return an electric power to a higher-level power supply.

In the power supply, the primary-side power supply of the positive-side parallel circuit and the primary-side power supply of the negative-side parallel circuit may be rechargeable batteries that absorb a regenerated power.

In the power supply, the primary-side power supply of the positive-side parallel circuit and the primary-side power supply of the negative-side parallel circuit may serve as power regenerating circuits that return an electric power to a higher-level power supply.

A semiconductor test device may comprise the power supply employed as at least any one of Device Power Supply or a power supply for Parametric Measurement Unit.

According to the present invention, it is feasible to implement the power supply whose power supply circuit itself has small power consumption in all quadrants and which has high efficiency and the semiconductor test device using the same.

Other features and advantages may be apparent from the following detailed description, the accompanying drawings and the claims.

### BRIEF DESCRIPTION OF THE DRAWINGS

FIG. 1 is a circuit diagram showing an embodiment of the present invention; and

FIG. 2 is a circuit diagram showing an example of a common step-down synchronous rectifying converter.

### DETAILED DESCRIPTION

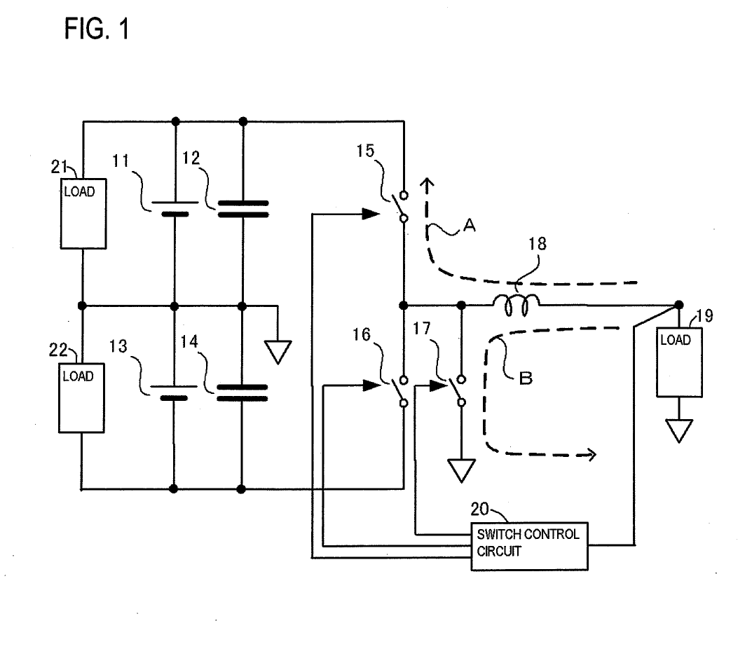

The present invention will be explained in detail with reference to the drawings hereinafter. FIG. 1 is a circuit diagram showing an embodiment of the present invention. In FIG. 1, on the positive side, a primary-side power supply 11 and a by-pass capacitor 12 used for voltage stabilization are connected in parallel, and a negative polarity side of the parallel circuit is connected to a common potential point. On the negative side, a primary-side power supply 13 and a by-pass capacitor 14 used for voltage stabilization are connected in parallel, and a positive polarity side of the parallel circuit on the negative side is connected to the common potential point. A positive polarity side of the parallel circuit on the positive side is connected to a negative polarity side of the parallel circuit on the negative side via a series circuit that consists of a first switch 15 and a second switch 16, which are formed of MOSFET, or the like.

A connection point between the first switch 15 and a second switch 16, which are connected in series, is connected to the common potential point via a third switch 17. Also, one end of a load 19 is connected to the connection point between these switches, and the other end of the load 19 is connected to the common potential point.

A connection point between an inductor 18 and the load 19 is connected to a switch control circuit 20. The switch control circuit 20 generates drive pulse signals that drive the first switch 15, the second switch 16 and the third switch 17 to open/close selectively, based on respective operation modes. In this case, a pulse width of these drive pulse signals is controlled to sense a voltage or a current at the end portion of the load 19 and keep the voltage or the current at the end portion of the load 19 constant.

A load 21 is connected in parallel with the parallel circuit on the positive side, and a load 22 is connected in parallel with the parallel circuit on the negative side.

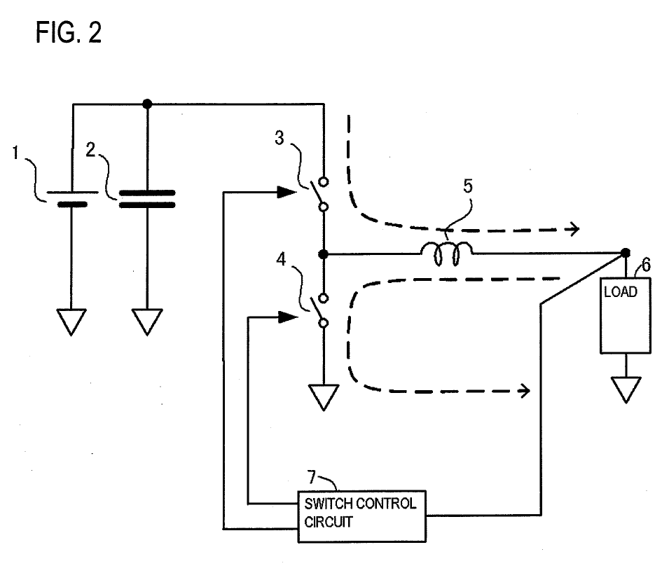

For example, an operation taken when a positive voltage is fed to the terminal of the device under test as the load 19, for example, will be explained hereunder. The switch control circuit 20 generates a period pulse to open/close alternately the first switch 15 and the third switch 17. At this time, the second switch 16 is kept in its open state. The switch control circuit 20 controls a width of an output pulse such that a voltage at the terminal of the device under test as the load 19 is kept at a predetermined voltage. This operation is similar to the operation of the synchronous rectifying converter explained in FIG. 2.

Next, an operation taken when the load 19 is a battery, or the like to discharge an energy will be explained hereunder. Here, the load 19 is the battery that generates a positive voltage, and an operation taken when a predetermined current is pulled out from the load 19 is supposed. It is supposed that a direction of the current in this case is given as indicated with a broken-line arrow A or a broken-line arrow B in FIG. 1.

The switch control circuit 20 controls a width of a switching pulse, which is applied to open/close alternately the first switch 15 and the third switch 17, such that a quantity of current from the load 19 is kept constant. When the first switch 15 and the second switch 16 are in their open state and the third switch 17 is in its close state, a current is fed from the load 19 to the ground via the inductor 18 and the third switch 17 and then is returned to the load 19, as indicated with the broken-line arrow B. At this time, the energy being discharged from the load 19 is accumulated in the inductor 18.

When the second switch 16 and the third switch 17 are in their open state and the first switch 15 is in its close state, the current is fed from the load 19 to the primary-side power supply 11 on the positive side via the inductor 18 and the first switch 15. At this time, the energy being discharged from the load 19 and the inductor 18 is recovered by the regenerating action on the primary-side power supply 11. This regenerated energy is consumed by the load 21.

The operation at the positive voltage explained as above is applied similarly to the operation at the negative voltage. That is, in the case of the negative voltage, the second switch 16 and the third switch 17 take an action alternately, and the load 22 consumes the energy being regenerated on the primary-side power supply 13 side on the negative side.

Also, when a large current must be fed at the voltage in vicinity of 0 V, the switch control circuit 20 executes a switching operation that brings alternately three switches consisting of the first switch 15, the second switch 16 and the third switch 17 or two switches consisting of the first switch 15 and the second switch 16 into the close state. In this case, when three switches consisting of the first switch 15, the second switch 16 and the third switch 17 are opened/closed, these switches are controlled to prevent the flow of the penetrating current in such a manner that two switches or more are not brought simultaneously into the close state.

As apparent from the above explanation of the operation, it is appreciated that a four-quadrant operation on such a plane that an abscissa denotes a voltage and an ordinate denotes an electric current can be realized.

The switching operation is executed by using a combination of the primary-side power supplies 11, 13 on both the positive side and the negative side and three switches consisting of the first switch 15, the second switch 16 and the third switch 17. As a result, it is feasible to implement the power supply whose is able to carry out the four-quadrant operation indispensable to the power supply for use in measurement, whose power supply circuit itself has small power consumption in the operation in all quadrants, and which has high efficiency.

Also, the loads 21, 22 are utilized as not only a simply load but also a power regenerative circuit, and such a configuration is employed that the regenerated power is returned to the system power supply or the line power supply. Therefore, a reduction in power consumption of the overall power supply can be achieved.

Here, the loads 21, 22 may also be formed of a power regenerating circuit that returns an electric power to the higher-level power supply. In this case, the loads 21, 22 may be formed as an integrated circuit.

Also, the primary-side power supplies 11, 13 themselves on both the positive and negative sides may be formed in the form such as the so-called rechargeable battery that absorbs the regenerated power, or the like. Also, the primary-side power supplies 11, 13 may also be used as a power regenerating circuit that returns the power to the higher-level power supply.

Also, the switch control circuit 20 may be formed the circuit in the system that controls not a width of an output pulse but a voltage or a current at a frequency of occurrence of the pulse waveform.

Also, when the MOSFET is used, the third switch 17 may be formed of two MOSFETs that are cascade-connected to respond to the voltage with both polarities.

As explained above, according to the present invention, the power supply which can handle the four-quadrant operation and which has high efficiency can be implemented, and is suitable for the power supply for use in various measurements. The power supply in the semiconductor test device, particularly DPS (Device Power Supply) or the power supply for PMU (Parametric Measurement Unit), can be constructed by the present power supply. As a result, a substantially greater power saving can be expected as the whole semiconductor test device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A power supply, comprising:
a positive-side parallel circuit whose negative polarity side is connected to a common potential point, the positive-side parallel circuit having a primary-side power supply and a by-pass capacitor used for voltage stabilization, which are connected in parallel;
a negative-side parallel circuit whose positive polarity side is connected to the common potential point, the negative-side parallel circuit having a primary-side power supply and a by-pass capacitor used for voltage stabilization, which are connected in parallel;
a series circuit having a first switch and a second switch, the series circuit having one end which is connected to a positive polarity side of the positive-side parallel circuit and other end which is connected to a negative polarity side of the negative-side parallel circuit;
a third switch having one end which is connected to a connection point between the first switch and the second switch and other end which is connected to the common potential point;
a load having one end which is connected to a connection point between the connection point between the first switch and the second switch and the third switch via an inductor and other end which is connected to the common potential point; and
a switch control circuit configured to drive selectively respective switches by sensing a signal at a connection point between the inductor and the load.

2. A power supply according to claim 1, further comprising:
a first load which is connected to in parallel with the positive-side parallel circuit; and
a second load which is connected to in parallel with the negative-side parallel circuit.

3. A power supply according to claim 2, wherein the first load and the second load are power regenerative circuits that return an electric power to a higher-level power supply.

4. A power supply according to claim 1, wherein the primary-side power supply of the positive-side parallel circuit and the primary-side power supply of the negative-side parallel circuit are rechargeable batteries that absorb a regenerated power.

5. A power supply according to claim 1, wherein the primary-side power supply of the positive-side parallel circuit and the primary-side power supply of the negative-side parallel circuit serve as power regenerating circuits that return an electric power to a higher-level power supply.

6. A semiconductor test device comprising:
the power supply set forth in claim 1 employed as at least any one of Device Power Supply or a power supply for Parametric Measurement Unit.
